(19) United States
(12) Patent Application Publication
(10) Pub. No.: US 2002/0129370 A1
(43) Pub. Date: Sep. 12, 2002

(54) Method and system for implementing an electronic program guide

(76) Inventor: Dan Kikinis, Saratoga, CA (US)

Correspondence Address: John Patrick Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/071,091

(22) Filed: Feb. 7, 2002

Related U.S. Application Data
(60) Provisional application No. 60/267,992, filed on Feb. 9, 2001.

(51) Int. Cl. G06F 13/00

(52) U.S. Cl. 725/55; 709/216

(57) ABSTRACT

The invention provides a method for implementing an electronic program guide. The method comprises partitioning a data storage area into a plurality of discrete storage areas; receiving programming information from a source; and storing the received program information, in its entirety, in the discrete storage areas, each discrete storage area storing programming information that is related in accordance with a predefined criterion.

### PRIORITY

The present application hereby claims the benefit of the filing date of a related Provisional Application filed on Feb. 9, 2001, and assigned Application Serial No. 60/267,992.

### FIELD OF THE INVENTION

This invention relates to electronic program guides. In particular it relates a method and system for implementing an electronic program guide storing television programming information.

### BACKGROUND

Electronic Program Guides (EPGs) for storing program information such as television programming information have several advantages over printed program guides. One advantage is that while printed program guides are difficult to update with last minute program changes and can thus be inaccurate, EPGs may be updated with the latest program changes with relative ease. Another advantage that EPGs have over printed guides is that the printed guides tend to be bulky because of the amount of information they contain. This makes them cumbersome to use. In contrast, EPGs have powerful searching capabilities making it easy to locate a desired channel.

In more complex systems, an EPG may provide selected programming information to a videocassette recorder (VCR) to allow the VCR to record a desired channel automatically. In other systems, a television receiver may be turned on and tuned to a desired channel using selected information from the EPG. Because of these advantages EPGs are gaining in popularity. However, one difficulty in implementing an EPG arises from the sheer volume of data that needs to be stored and manipulated. As an example, it is not unusual for an EPG for a satellite television system to have 10,000 distinct events (i.e., a unique combination of show and time). More memory may be added to the EPG to hold the data, but this is an expensive solution. Further, the large volume of the EPG data also means that more processing power is needed to manipulate (search and sort) the data, which also pushes up costs. Thus, there is a need to manage EPG data in an efficient manner to conserve valuable memory and make manipulation of the EPG data more efficient.

### SUMMARY OF THE INVENTION

According to one aspect of the invention, there is provided a method for implementing an electronic program guide, the method comprising partitioning a data storage area into a plurality of discrete storage areas receiving programming information from a source; and storing the received programming information, in its entirety, in the discrete storage areas, each discrete storage area storing programming information that is related in accordance with a predefined criterion.

According to another aspect of the invention there is provided a system for implementing an electronic program guide, the system comprising input circuitry configured to receive programming information; a processor coupled to the input circuitry; a program memory coupled to the processor to store a preferred program which controls operation of the processor; and a data storage area coupled to the processor, the data storage area being partitioned into a plurality of discrete storage areas, wherein under control of the control program the CPU operates to store programming information received by the input circuitry in the discrete storage areas, each discrete storage area storing programming information that is related in accordance with a predefined criterion.

### BRIEF DESCRIPTION OF THE DRAWINGS

FIG. 1 illustrates a prior art method for implementing an EPG;

FIG. 2 shows a method for implementing an EPG in accordance with one embodiment of the invention;

FIG. 3 shows an organizational structure of a memory for storing an EPG in accordance with the prior art;

FIG. 4 shows an organizational structure of a memory for storing an EPG in accordance with one embodiment of the invention;

FIG. 5 shows an example of a record type used in accordance with one embodiment of the present invention;

FIG. 6 shows an example of a method for implementing an EPG in accordance with another embodiment of the invention; and

FIG. 7 shows a block diagram of an EPG system in accordance with one embodiment of the invention.

### DETAILED DESCRIPTION

A method and system for implementing an EPG is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

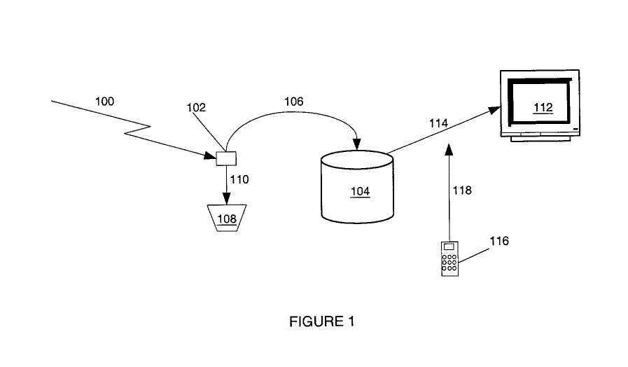

FIG. 1 of the drawings shows a prior art method for implementing an EPG. Referring to FIG. 1, an incoming EPG data stream is indicated by reference numeral 100. The EPG data stream 100 is stored in a first storage area 102. Thereafter a selection process is executed wherein it is decided which components of the incoming EPG data stream 100 are required and which components are not required. The components of the incoming EPG data stream 100 that are required are moved into a second storage area 104 as indicated by arrow 106. Components of the EPG data stream 100 that are not required are moved into a garbage collection area 108 as indicated by arrow 110. Components of the EPG data stream 100 that are stored in the storage area 104 are sent to a display 112 as indicated by arrow 114. Controlling which components to send to display 112 is based on user interaction with a remote controller 116 and activity arrow 118. It will be appreciated that crucial to the prior art method shown in FIG. 1 of the drawings is that a selection process uses certain selection criteria to decide which components of the incoming EPG data stream 100 to store and which components to move into garbage storage area 106. By using this selection process the data that is stored in data storage area 104 can be kept to within certain size limits.

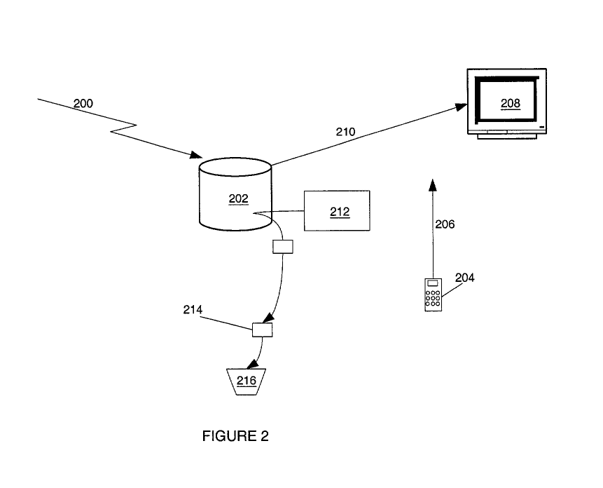

As described below, the method and system in accordance with embodiments of the present invention do not require compression of the incoming EPG data stream or a selection of any components thereof. FIG. 2 of the drawings shows a method for implementing an EPG in accordance with one embodiment of the invention. Referring to FIG. 2, an incoming EPG data stream 200 is stored in its entirety in a storage area 202. Thereafter a user can, through input via a remote controller 204 and activity arrow 206, display a selection of data from storage area 202 on a display 208. Arrow 210 indicates the selection being sent to display 208. Process 212 continuously goes through storage area 202 in a cyclical manner, independently of the incoming EPG data stream 200, and removes superfluous or unwanted information by cleaning up storage area 202 as will be described in greater detail below. Part of process 212 includes removing unwanted records 214 from storage area 202 and dumping those records into a garbage collection area 216.

One difference between the embodiment of the invention illustrated in FIG. 2 of the drawings and the prior art illustrated in FIG. 1 of the drawings is that the incoming EPG data stream according to the prior art is first stored in a first storage area and thereafter a decision is made as to whether to store components thereof in a second memory storage area or not, whereas in the embodiment of the invention shown in FIG. 2 of the drawings the entire incoming EPG data stream is stored in a database within storage area 202 and only then, at a later state (after the EPG incoming stream has been stored in database 202) does cyclical process 210 execute to remove superfluous data entries in the database in storage area 202. These superfluous data entries could include, for example, entries that have expired.

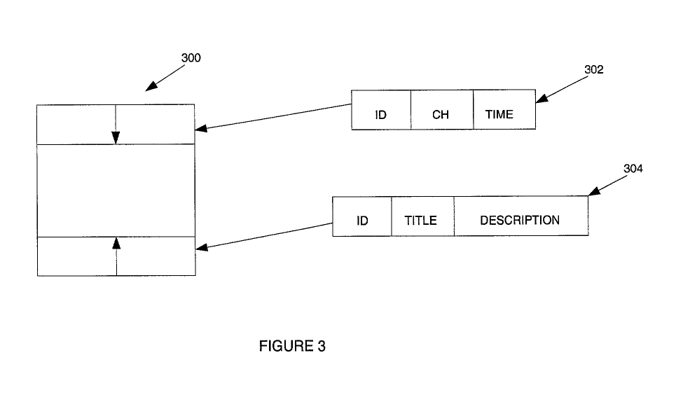

Referring to FIG. 3 of the drawings, a simplified block diagram showing an internal organization of memory storage area 104 in FIG. 1 of the drawings is indicated generally by reference numeral 300. The organization of data memory 300 includes from the top down one type of record 302 and from the bottom up another type of record 304, or vice versa. Examples of the record types 302 and 304 are also shown in FIG. 3. It will be seen that the record type 302 includes an identification (ID), a channel number, and a time when a show will air, but no title or description., Record type 304 includes an ID, a title, and a description, but no channel number or time. As an example of how these record types are used in the prior art, consider the program ABC news, which occurs every day at 5:00 p.m. and at 7:00 p.m. For every day of the week, record 302 shows the ID, which may be a number; the channel, e.g., channel 7; and a time, e.g., 5:00 p.m. or 7:00 p.m. (and maybe the date or day of the week, etc.). To avoid duplication of information each broadcast time of ABS news is associated with a single record 304. Thus, for example, if one considers upcoming programs within a two-week window there would be 14 entries with a different broadcast time. But all of those records would share only one record 304 which, for example, says “ABC news” and says “evening news” under its title and description respectively. Thus, all 14 shows share one description record. Implicit in being able to implement a memory organizational structure as shown in FIG. 3 of the drawings it is necessary that the data in the incoming EPG data stream in the prior art be presorted into record types 302 and 304.

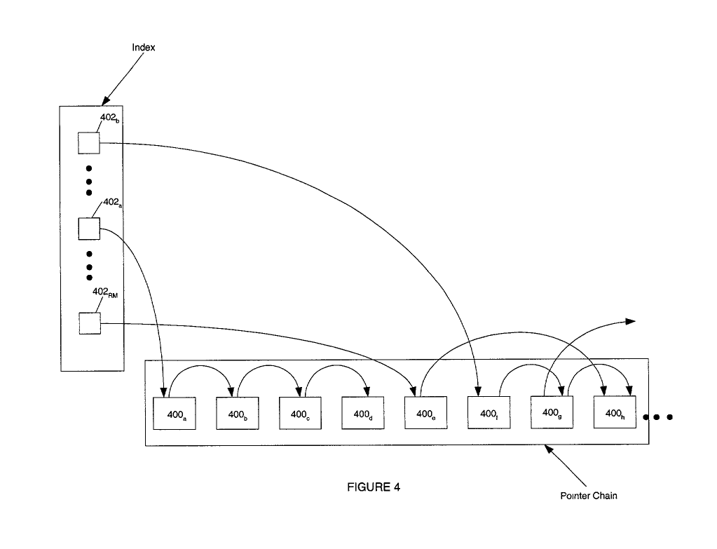

FIG. 4 of the drawings shows one example of a memory organizational structure used to implement an EPG in accordance with one embodiment of the invention. Referring to FIG. 4, memory storage area 202 is divided into a number of discrete storage areas 400_{a . . . z}. Discrete storage area 400ₑ is not used to store actual EPG data. Instead discrete storage area 400ₑ points to other storage areas that contain superfluous data or data that is no longer required. It will be seen that the discrete storage areas 400_{a . . . z} form a pointer chain. An index of pointers 402_{a . . . z} is maintained to keep track of the content of the discrete storage areas in the pointer chain. For example, as shown in FIG. 4 of the drawings, the index comprises element 402ₐ which points to discrete storage area 400ₐ which may, for example, store programs which start with the letter “A”. Element 402_{b} in the index points to discrete storage area 400_{f} which, for example, contains programs which start with the letter “F” and so on. The index also includes element 402_{RM} which points to discrete storage area 400ₑ. Incoming EPG data is stored in any one of discrete storage areas 400_{a . . . z} in the pointer chain depending on which of the discrete storage areas are available. For example, as shown in FIG. 4, discrete storage area 400ₕ is available since discrete storage area 400ₑ points to element 400ₕ. When the incoming EPG data is received a check is made using element 402_{RM} from the index and discrete storage area 400ₑ from the pointer chain to determine which discrete storage area is available for storage. The incoming EPG data is then stored in the next available storage area and the index is updated. By using the index and the pointer chain as illustrated in FIG. 4 there is no need to compress the data in storage area 202 into a table. One advantage of storing or organizing storage area 202 using the organizational structure shown in FIG. 4 of the drawings is that to look for a title with the letter “Z”, for example, there is no need to go through the whole pointer chain starting at 400ₐ, etc., until you get to the letter “Z”. The index of pointers 402_{a . . . z} facilitates rapid access to data within the pointer chain. For example, in FIG. 4 of the drawings, pointer 402_{b} from the index points to discrete storage area 400_{f} in the pointer chain thereby indicating the location of the first program starting with the letter “B”. The memory organizational scheme shown in FIG. 4 of the drawings is not limited to only letters. Thus, there may be additional pointer chains for IDs, show times, names, etc., for any structure which requires sorting or searching.

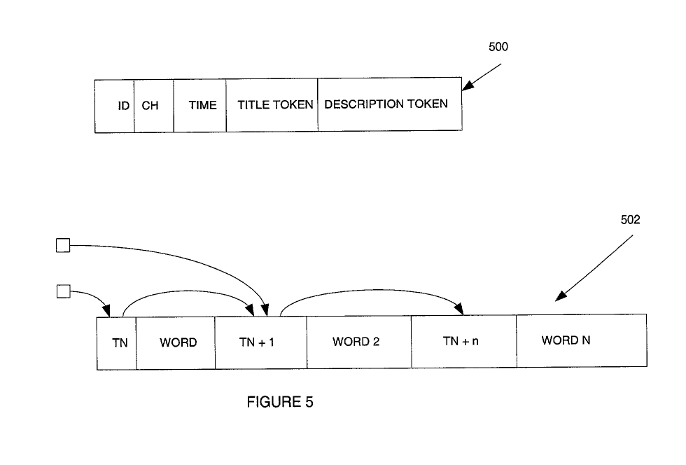

FIG. 5 of the drawings shows examples of records which may be stored in memory storage area 202 in accordance with one embodiment of the invention. Referring to FIG. 5, reference numeral 500 indicates a first type of record which includes ID, channel, time, title, and description fields (date and other additional fields may be present but these are not shown). However, the lengthy fields such as the title and description fields are compressed using tokens. Thus, the full title is represented by a title token and the full description is represented by a description token. A second type of record, indicated by reference numeral 502, provides a token dictionary comprising the meanings of the tokens in record 500. Each token may be associated with a complete or partial word or even multiple words. For example, the word “the” is represented by a token, and instead of requiring three characters, storage of the word “the” requires only a single token. In another example, the word “news” which appears in a great many of today's program titles could be replaced by a single token.

Depending on the preferred size of the dictionary and the number of words included therein, typically one would choose between 8- or 16-bit tokens. If, for example, the 1000 most frequently used words, which comprise up to 95% of the words in program titles and descriptions, is replaced with tokens, the resulting compression then allows the title and description to be included in the same record as the ID, channel, time, etc.

Because the token dictionary is also a table in the database, the dictionary can be modified as the descriptions of programs change by adding new words and removing old words no longer used. Thus, providers at a source or headend could analyze programming descriptions and titles for the next two to three months and update the token dictionary accordingly. In such a case record 500, which is transmitted from the headend, is exactly what is stored in the discrete storage areas 400_{a . . . z} in FIG. 4 of the drawings.

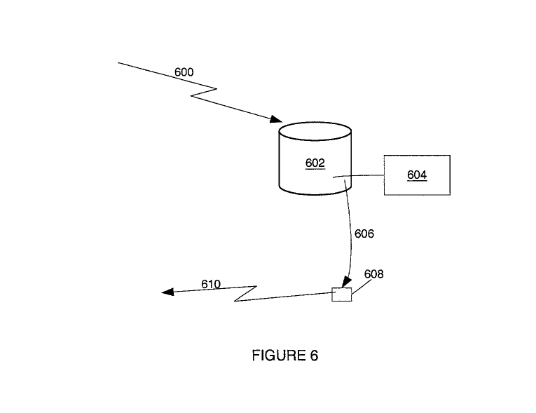

FIG. 6 of the drawings shows another embodiment of the present invention method for implementing an EPG. Referring to FIG. 6, an incoming EPG data stream is received by an EPG system in accordance with one embodiment of the invention and stored in its entirety in a database within memory storage area 602. Process 604 then cyclically goes through the records within the database in memory storage area 602 and recognizes gaps in the database. This is possible because the required range is known i.e. the next 2 days etc. After determining what data is missing, information about the missing data is sent by arrow 606 to process 608 which from time to time sends a request 610 to the headend to transmit the missing data. The frequency of requests from process 608 can be interval-based, poll-based, or based on the number of missing data requests. Thus, only the missing data is received as requested. No filtration or selection of the received data is required.

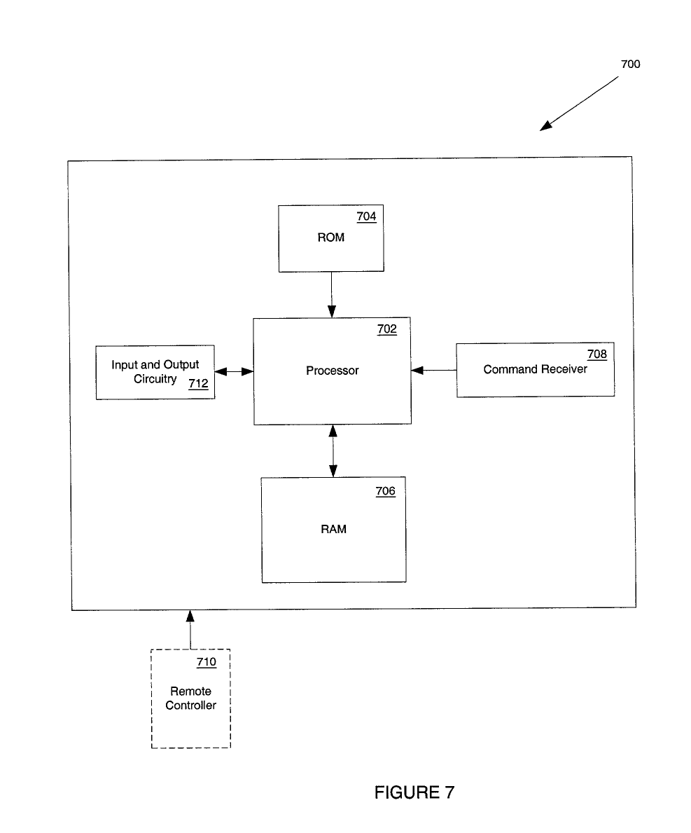

FIG. 7 of the drawings shows a block diagram of an EPG system 700 in accordance with one embodiment of the invention. The system includes a processor 702 and a read-only memory storage 704 which stores a sequence of instructions which when executed by a processor 702 causes processor 702 to perform a method for implementing an EPG as described. The components of system 700 include a random access memory 706 wherein a database storing programming information as described above is stored. A command receiver 708 is coupled to processor 702 and includes circuitry to receive user input commands to control operation of system 700. Such user input commands are typically input via a remote controller 710. System 700 also includes input and output circuitry 712 which is coupled to processor 702, via which programming information from a headend may be received. The circuitry 712 is also used to send a request such as the request indicated by reference numeral 606 in FIG. 6 of the drawings to a headend, requesting missing information. The design and integration of blocks 702, 704, 706, 708 and 712 are well known and are therefore not further described.

In the foregoing, the present invention has been described with reference to specific exemplary embodiments thereof. It will, however, be evident that various modifications and changes may be made thereto without departing from the broader spirit and scope of the present invention. In particular, the separate blocks of the various block diagrams represent functional blocks of methods or apparatuses and are not necessarily indicative of physical or logical separations or of an order of operation inherent in the spirit and scope of the present invention. The present specification and figures are accordingly to be regarded as illustrative rather than restrictive.

Although the present invention has been described with reference to specific exemplary embodiments, it will be evident that the various modifications and changes can be made to these embodiments without departing from the broader spirit of the invention as set forth in the claims. Accordingly, the specification and drawings are to be regarded in an illustrative sense rather than in a restrictive sense.

What is claimed is:

1. A method for implementing an electronic program guide, the method comprising:
partitioning a data storage area into a plurality of discrete storage areas;
receiving programming information from a source; and
storing the received programming information, in its entirety, in the discrete storage areas, each discrete storage area storing programming information that is related in accordance with a predefined criterion.

2. The method of claim 1, wherein the programming information comprises information about individual programs.

3. The method of claim 2, wherein the programming information further comprises tokens used to describe the individual programs and a meaning associated with the tokens.

4. The method of claim 2, wherein the predefined criterion comprises a temporal relationship between the individual programs in the received program information.

5. The method of claim 3, wherein the predefined criterion comprises a numeric relationship between token numbers associated with the tokens.

6. The method of claim 1, wherein a size of each data storage area is selected to store program information about programs to be broadcast over a defined time interval.

7. The method of claim 1, further comprising referencing the information stored in each discrete storage area using a storage area identifier to identify the information within a storage area and an index of storage area identifiers.

8. The method of claim 7, wherein the storage area identifiers form a pointer chain.

9. The method of claim 7, wherein each discrete storage area which stores programming information no longer required is referenced by an empty identifier indicating that said discrete storage area is available for storing new information.

10. The method of claim 9, further comprising periodically determining if the programming information stored in each discrete storage area is relevant; and marking those storage areas containing programming information that is no longer relevant with the empty identifier.

11. The method of claim 10, wherein determining if the programming information stored in each discrete storage area is relevant comprises checking if the programming information is current or not.

12. The method of claim 1, further comprising determining that specific programming information is required; and requesting said specific programming information from the source.

13. The method of claim 12, wherein determining that specific programming information is required comprises checking if a user has input a request for specific programming information.

14. The method of claim 12, wherein determining that specific programming information is required comprises checking whether the programming information stored in the discrete storage areas is incomplete for want of specific programming information.

15. A system for implementing an electronic program guide, the system comprising:
input circuitry configured to receive programming information;
a processor coupled to the input circuitry;
a program memory coupled to the processor to store a control program which controls operation of the processor; and
a data storage area coupled to the processor, the data storage area being partitioned into a plurality of discrete storage areas, wherein under control of the control program the processor operates to store programming information received by the input circuitry in the discrete storage areas, each discrete storage area storing programming information that is related in accordance with a predefined criterion.

16. The system of claim 15, wherein the programming information comprises information about individual programs.

17. The system of claim 16, wherein the programming information further comprises tokens used to described the individual programs and a meaning associated with the tokens.

18. The system of claim 16, wherein the predefined criterion comprises a temporal relationship between the individual programs in the received programming information.

19. The system of claim 17, wherein the predefined criterion comprises a numeric relationship between token numbers associated with the tokens.

20. The system of claim 15, wherein a size of each data storage area is selected to store program information about programs to be broadcast over a defined time interval.

21. The system of claim 15, wherein the processor further operates to reference the information stored in each discrete storage area using a storage area identifier to identify the information within a storage area and an index of storage area identifiers.

22. The system of claim 21, wherein the storage area identifiers form a pointer chain.

23. The system of claim 21, wherein the processor operates to reference each discrete storage area which stores programming information no longer required with an empty identifier indicating that said discrete storage area is available for storing new information.

24. The system of claim 23, wherein the processor further operates to periodically determine if the programming information stored in each discrete storage area is relevant; and to mark those storage areas containing programming information that is no longer relevant with the empty identifier.

25. The system of claim 24, wherein the processor operates to determine if the programming information stored in each discrete storage are is relevant by checking if the program information is current or not.

26. The system of claim 15, wherein the processor operates to determine that specific programming information is required; and to request said specific programming information from a source of programming information.

27. The system of claim 26, wherein in determining that specific programming information is required the processor checks if a user has input a request for specific programming information.

28. The system of claim 26, wherein in determining the specific programming information is required, the processor checks the programming information stored in the discrete storage areas is incomplete for want of specific programming information.

29. A system for implementing an electronic guide, the system comprising a processor coupled to a memory having stored thereon a sequence of instructions which when executed by the processor cause the processor to perform a method comprising:
partitioning a data storage area into a plurality of discrete storage area;
receiving programming information from a source; and
storing the received programming information, in its entirety, in the discrete storage areas, each discrete storage area storing programming information that is related in accordance with a predefined criterion.

30. The system of claim 29, wherein the programming information comprises information about individual programs.

31. The system of claim 30, wherein the programming information further comprises tokens used to describe the individual program and a meaning associated with the tokens.

32. The system of claim 30, wherein the predefined criterion comprises a temporal relationship between the individual programs in the received program information.

33. The system of claim 31, wherein the predefined criterion comprises a numeric relationship between token numbers associated with the tokens.

34. The system of claim 29, wherein a size of each data storage area is selected to store program information about programs to be broadcast over a defined time interval.

35. The system of claim 29, wherein the method further comprises referencing the information stored in each discrete storage area using a storage area identifier to identify the information within a storage area and an index of storage area identifiers.

36. The system of claim 35, wherein the storage area identifiers form a pointer chain.

37. The system of claim 35, wherein each discrete storage area which stores programming information no longer required is referenced by an empty identifier indicating that said discrete storage area is available for storing new information.

38. The system of claim 37, wherein the method further comprises periodically determining if the programming information stored in each discrete storage area is relevant; and marking those storage areas containing programming information that is no longer relevant with the empty identifier.

39. The system of claim 38, determining if the programming information stored in each discrete storage identifier is relevant comprises checking if the programming information is current or not.

40. The system of claim 29, wherein the method further comprises determining that specific programming information is required and requesting said specific programming information from the source.

41. The system of claim 40, wherein determining the specific programming information is required comprises checking if a user has input a request for specific programming information.

42. The system of claim 40, wherein determining that specific programming information is required comprises checking whether the programming information stored in the discrete storage area is incomplete for want of specific programming information.

43. A system for implementing an electronic program guide, the system comprising:
means for partitioning a data storage area into a plurality of discrete storage areas;
means for receiving programming information from a source; and
means for storing the received programming information, in its entirety, in the discrete storage areas, each discrete storage area storing programming information that is related in accordance with a predefined criterion.

44. The system of claim 43, wherein the programming information comprises information about individual programs.

45. The system of claim 44, wherein the programming information further comprises tokens used to describe the individual programs and a meaning associated with the tokens.

46. The system of claim 44, wherein the predefined criterion comprises a temporal relationship between the individual programs in the received program information.

47. The system of claim 45, wherein the predefined criterion comprises a numeric relationship between token numbers associated with a token.

48. The system of claim 43, wherein a size of each data storage area is selected to store program information about programs to be broadcast over a defined time interval.

49. The system of claim 43, further comprising means for referencing the information stored in each discrete storage area using a storage area identifier to identify the information within a storage area and index of storage area identifiers.

50. The system of claim 49, wherein the storage area identifiers form a pointer chain.

51. The system of claim 49, wherein each discrete storage area which stores programming information no longer required is referenced by an empty identifier indicating that said discrete storage area is available for storing new information.

52. The system of claim 51, further comprising means for periodically determining if the programming information stored in each discrete storage area is relevant; and marking those storage areas containing program information that is no longer relevant with the empty identifier.

53. The system of claim 52, wherein determining if the programming information stored in each discrete storage area is relevant comprises checking if the programming information is current or not.

54. The system of claim 43, further comprising means for determining that specific programming information is required; and means to request said specific programming information from the source.

55. The system of claim 54, wherein the means for determining the specific programming information is required comprises means for checking if a user has input a request for specific programming information.

56. The system of claim 55, wherein the means to determine the specific programming information is required comprising means for checking whether the programming information stored in the discrete storage area is incomplete for want of specific programming information.
